(19) United States
(12) Patent Application Publication
(10) Pub. No.: US 2007/0146269 A1
(43) Pub. Date: Jun. 28, 2007

(54) Image display device and image display method

(76) Inventor: Masafumi Hoshino, Chiba-shi (JP)

Correspondence Address: BRINKS HOFER GILSON & LIONE, P.O. BOX 10395, CHICAGO, IL, 60610, US

(21) Appl. No.: 11/607,538

(22) Filed: Nov. 30, 2006

(30) Foreign Application Priority Data
Dec. 1, 2005 (JP) JP2005-348401
Nov. 16, 2006 (JP) JP2006-310391

(51) Int. Cl. G09G 3/36

(52) U.S. Cl. 345/88

(57) ABSTRACT

Provided are an image display device and an image display method capable of reducing the number of signal lines connected between a driver IC and a liquid crystal display portion and of displaying a preferable image. A liquid crystal display portion is divided into 16 division groups in a scanning direction. In order to scan the liquid crystal display portion, a common scanning signal line which is a scanning signal output line of a scanning signal line driver circuit is connected with a selective scanning signal line of each of the 16 division groups during switching for each of the groups. The common scanning signal line is commonly used among the plurality of selective scanning signal lines, so the number of wirings to be connected in the driver IC can be reduced.

This application claims priority under 35 U.S.C. § 119 to Japanese Patent Application Nos. JP 2005-348401, filed Dec. 1, 2005, and JP 2006-310391, filed Nov. 16, 2006, the entire content of which is hereby incorporated by reference.

### BACKGROUND OF THE INVENTION

1. Field of the Invention

The present invention relates to an image display method and an image display device such as an active matrix liquid crystal display device including switching elements.

2. Description of the Related Art

A liquid crystal display device is thin and has lower power consumption. Therefore, the liquid crystal display device has been widely used as a display of, for example, a television receiver, a computer, or a mobile telephone.

There are various types of liquid crystal display devices. An example of a widely used liquid crystal display device is an active matrix liquid crystal display device in which a switching element is provided in each pixel to drive a liquid crystal.

In this type of liquid crystal display device, a thin film transistor (TFT) is used as the switching element. A source of the TFT is connected with an image signal line and a gate thereof is connected with a scanning signal line.

When a scanning signal is applied to the gate to turn on the TFT, the liquid crystal is charged by an image signal applied to the source.

In manufacturing the liquid crystal display device, how to reduce a manufacturing cost thereof is important. Therefore, the following technique as described in JP 2003-058119 A has been proposed.

According to the technique, a plurality of (for example, three) image signal lines of a liquid crystal display portion in the active matrix TFT liquid crystal display device are connected with a connection terminal of an image signal line of a single (for example, one) driver IC at changed connection timings, thereby reducing the number of image signal lines for connecting the driver IC with the liquid crystal display portion.

In the conventional technique, a single image signal terminal provided in the driver IC is commonly used among the plurality of image signal lines of the liquid crystal display portion. However, an image signal is an analog signal, so it is difficult to rapidly switch among the image signal lines at a predetermined timing.

### SUMMARY OF THE INVENTION

Therefore, an object of the present invention is to reduce the number of image signal lines for connecting a driver IC with a liquid crystal display portion and display a preferable image.

In order to achieve the above-mentioned object, according to the present invention, there is provided an image display device, including:

an image display portion in which a plurality of pixel lines, each of which includes a plurality of pixels, are arranged;

image signal output means for outputting an image signal to the pixels;

scanning signal output means including:
a plurality of first scanning signal lines connected with the pixel lines, for supplying, to the pixels of each of the pixel lines, a scanning signal for applying the output image signal; and
a second scanning signal line for sending the scanning signal; and

scanning signal line connecting means for connecting a first scanning signal line connected with a pixel line to which the scanning signal is supplied, of the plurality of first scanning signal line, with the second scanning signal line (first structure).

In the first structure, there may be adopted such a structure that:

the image display portion includes a plurality of pixel line groups, each of which has pixel lines connected with the different second scanning signal line through the first scanning signal line; and

the scanning signal line connecting means performs one of connection and disconnection between the first scanning signal line and the second scanning signal line for each of pixel line groups (second structure).

In the first or second structure, there may be adopted such a structure that:

the scanning signal line connecting means includes switching means for parallel connecting the plurality of first scanning signal lines with the second scanning signal line; and

connection of the switching means is performed for each of the first scanning signal lines to connect the first scanning signal lines with the second scanning signal line (third structure).

In the third structure, the image display device may further include state holding means for supplying, to a pixel line connected with a first scanning signal line, a state holding signal for holding a state in which the image signal is applied when the first scanning signal line is disconnected with the second scanning signal line (fourth structure).

In the fourth structure, there may be adopted such a structure that: when the first scanning signal line is disconnected with the second scanning signal line, the state holding means supplies the state holding signal by connecting a state holding signal line with the disconnected first scanning signal line (fifth structure).

In any one of the first to fifth structures, the image display device may further include an image signal line for supplying the image signal, and there may be adopted such a structure that:

the first scanning signal lines are separately provided for three pixels corresponding to three primary colors; and

the image signal line is commonly provided to the three pixel (sixth structure).

In the second structure, there may be adopted such a structure that:

each of the pixel line groups is formed for pixels of colors corresponding to three primary colors (seventh structure).

In the seventh structure, the image display device may further include driving means for driving the image signal output means and the scanning signal line connecting means to scan the pixels for each of the pixel line groups for light emission (eighth structure).

In the eighth structure, there may be adopted such a structure that: the driving means reverses a polarity of a voltage applied to a pixel electrode every time each of the pixel line group is scanned (ninth structure).

Further, according to the present invention, there is provided an image display method for an image display device in which pixels corresponding to three primary colors are connected with a single image signal line, including:

a first light emission step of scanning pixels corresponding to a first color of the three primary colors to produce light emission in the pixels corresponding to the first color;

a second light emission step of scanning pixels corresponding to a second color of the three primary colors to produce light emission in the pixels corresponding to the second color; and

a third light emission step of scanning pixels corresponding to a third color of the three primary colors to produce light emission in the pixels corresponding to the third color (tenth structure).

According to the present invention, the scanning signal line is dynamically connected between a source which supplies the scanning signal and a pixel line which is a portion to which the scanning signal is supplied. Therefore, the number of signal lines connected between a driver IC and a liquid crystal display portion can be reduced and a preferable image can be displayed.

### BRIEF DESCRIPTION OF THE DRAWINGS

In the accompanying drawings:

FIG. 1 is an explanatory block diagram showing a structural example of an image display device according to an embodiment of the present invention;

FIGS. 2A and 2B show pixel arrangements of a liquid crystal display portion for comparison of the present invention with a conventional example;

FIG. 3 is an explanatory diagram showing a mechanism for group selection;

FIG. 4 is an explanatory diagram showing an entire wiring structure of a group selective scanning circuit;

FIG. 5 is a waveform diagram showing output timings of various signals;

FIG. 6 is a table in which the image display device according to the embodiment of the present invention is compared with an image display device which is a conventional product;

FIG. 7 is an explanatory diagram showing a wiring structure and the like in Modified Example 1;

FIG. 8 is an explanatory diagram showing a method of scanning a liquid crystal display portion in Modified Example 1;

FIG. 9 is an explanatory diagram showing a wiring structure and the like in Modified Example 2;

FIG. 10 is an explanatory diagram showing a method of scanning a liquid crystal display portion in Modified Example 2; and

FIG. 11 is an explanatory diagram showing another method of scanning the liquid crystal display portion in Modified Example 2.

### DETAILED DESCRIPTION OF THE PREFERRED EMBODIMENT

### (1) Summary of Embodiment

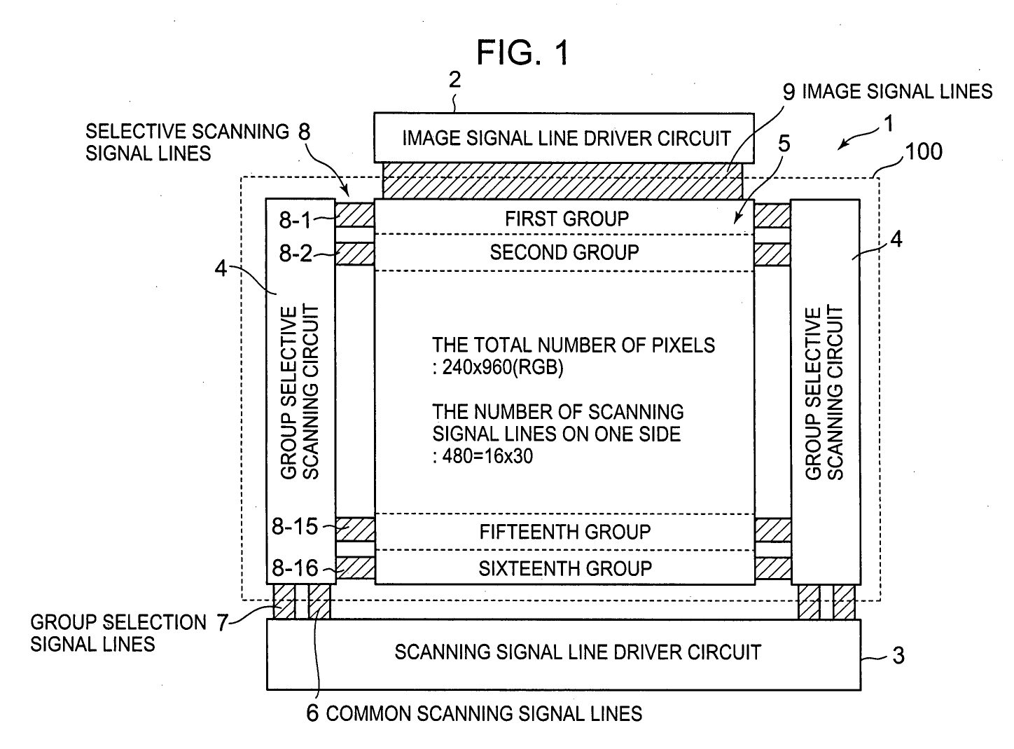

A liquid crystal display portion 5 (FIG. 1) is divided into 16 division groups in a scanning direction. In order to scan a liquid crystal display portion 5, a common scanning signal line 6 which is a scanning signal output line of a scanning signal line driver circuit 3 is connected with a selective scanning signal line 8 of each of the 16 division groups during switching for each of the groups. That is, the scanning signal line driver circuit 3 causes the common scanning signal line 6 to be connected with the selective scanning signal line 8 of a first group to scan the first group. Then, the scanning signal line driver circuit 3 causes the common scanning signal line 6 to be connected with the selective scanning signal line 8 of a second group to scan the second group. Therefore, scanning is performed while the common scanning signal line 6 is connected among the first group to a sixteenth group. As described above, the common scanning signal line 6 is commonly used among the plurality of selective scanning signal lines 8, so the number of wirings to be connected in a driver IC can be reduced. When R, G, and B color filters are arranged in not a lateral direction but a longitudinal direction, the number of image signal lines is reduced and the number of scanning signal lines is increased. Thus, a scanning speed is increased. A scanning signal is a digital signal, so high-speed scanning can be easily performed.

In this embodiment, a single image signal line is connected with pixels corresponding to R, G, and B. Therefore, pixels corresponding to R are first scanned and then pixels corresponding to G are secondly scanned. After that, pixels corresponding to B are scanned. That is, scanning is performed for each color, thereby reducing a variation in image signal traveling on the image signal line.

### (2) Detail of Embodiment

FIG. 1 is an explanatory block diagram showing an example of a structure of an image display device according to an embodiment of the present invention.

An image display device 1 includes the liquid crystal display portion 5, an image signal line driver circuit 2, a scanning signal line driver circuit 3, and group selective scanning circuits 4. A TFT liquid crystal panel 100 includes the liquid crystal display portion 5 and the group selective scanning circuits 4.

The liquid crystal display portion 5 is, for example, an active matrix a-Si TFT liquid crystal panel and satisfies a specification called a quarter video graphics array (QVGA) in which the number of pixels is 240×960 (rows and columns). The specification is used for, for example, a relatively small display screen such as a display screen of a display of a mobile telephone.

Hereinafter, in the liquid crystal display portion 5 shown in FIG. 1, a side on which the image signal line driver circuit 2 is provided is assumed to be an upper side and a side on which the scanning signal line driver circuit 3 is provided is assumed to be a lower side.

The image signal line driver circuit 2 for supplying image signals to the liquid crystal display portion 5 is provided on the upper side of the liquid crystal display portion 5.

Image signal lines (240 lines) 9 are provided between the image signal line driver circuit 2 and the liquid crystal display portion 5 for each of pixel lines thereof. Image signals are supplied from the image signal line driver circuit 2 to each of the pixel lines through the image signal lines 9.

The image signals are analog signals. A gray level of each pixel is specified by a voltage of each of the image signals.

The group selective scanning circuits 4 for applying scanning signals to the liquid crystal display portion 5 are provided on both the right and left sides of the liquid crystal display portion 5. The group selective scanning circuits 4 are included as constituent parts in the TFT liquid crystal panel 100. Each of the group selective scanning circuits 4 corresponds to a connection portion between the order controller 3 and the TFT liquid crystal panel 100.

For example, the group selective scanning circuits 4 are alternately connected with scanning signal lines of the liquid crystal display portion 5 to made two-part connection.

The scanning signal lines of the liquid crystal display portion 5 are provided for respective pixel lines, so each of the group selective scanning circuits 4 is connected with 480 (=960/2) scanning signal lines.

In this embodiment, the reason why the scanning signal lines of the liquid crystal display portion 5 are divided into right and left groups is that the liquid crystal display portion 5 is located in the central portion of the image display device 1.

As described above, the two group selective scanning circuits 4 are located because of a convenient layout of the liquid crystal display portion 5. One of the group selective scanning circuits 4 (for example, the group selective scanning circuit 4) can be connected with all the scanning signal lines.

Hereinafter, for simple explanation, one of the group selective scanning circuits 4 which is located on the left side of the liquid crystal display portion 5 will be described. This description can be applied as it is to the other of the group selective scanning circuits 4 which is located on the right side of the liquid crystal display portion 5.

The group selective scanning circuit 4 is connected with the selective scanning signal lines 8 of the 16 division groups into which the liquid crystal display portion 5 is divided in a longitudinal direction.

As described above, the liquid crystal display portion 5 is divided into the 16 division groups through the group selective scanning circuit 4. The 16 division groups are respectively referred to as the first group, the second group, . . . , and the sixteenth in order from the upper side.

Hereinafter, the selective scanning signal line 8 of an nth group (n is an integer of 1 to 16) which is connected with scanning signal lines is expressed as, for example, a selective scanning signal line 8-n. When not particularly distinguished from one another, the selective scanning signal lines are merely referred to as the selective scanning signal line 8.

The scanning signal lines of the liquid crystal display portion 5 which are connected with the group selective scanning circuit 4 are divided into 16 groups, so each selective scanning signal line 8-n is composed of 30 (=480/16) scanning signal lines.

Although the selective scanning signal line 8-n separated for each of the groups is schematically shown in FIG. 1, this does not mean physical separation.

The scanning signal line driver circuit 3 for supplying the scanning signals to the liquid crystal display portion 5 is provided on the lower side of the liquid crystal display portion 5. The scanning signal line driver circuit 3 and the image signal line driver circuit 2 compose the driver IC.

When a scanning signal outputted from the scanning signal line driver circuit 3 is applied to a pixel line corresponding to a row of the liquid crystal display portion 5, respective pixels of the pixel line are charged and driven by the image signals supplied through the image signal lines 9.

A group selection signal line 7 and the common scanning signal line 6 are provided between the scanning signal line driver circuit 3 and the group selective scanning circuit 4.

The common scanning signal line 6 is composed of 30 scanning signal lines. When the scanning signal line driver circuit 3 sends a signal to the group selection signal line 7, one of the selective scanning signal lines 8-1 to 8-16 can be selected to connect the selected selective scanning signal line 8-n with the common scanning signal line 6.

The scanning signal line driver circuit 3 causes the common scanning signal line 6 to be connected with the selective scanning signal line 8-1 to scan the first group. Then, the scanning signal line driver circuit 3 selects the selective scanning signal line 8-2 to scan the second group. Therefore, the liquid crystal display portion 5 is scanned in a direction from an uppermost row to a lowermost row while the common scanning signal line 6 is sequentially connected among the selective scanning signal lines 8-1 to 8-16.

As described above, the common scanning signal line 6 is commonly used among the selective scanning signal lines 8-1 to 8-16, so the number of scanning signal lines to be connected with the scanning signal line driver circuit 3 can be reduced. Even when the group selection signal line 7 is further provided, the number of wirings connected between the TFT liquid crystal panel 100 and the order controller 3 can be reduced.

The group selection signal line 7 includes wirings for group selection (group non-selection line 15 and group selection line 16 described later), a Vcom line, and a Goff line 17, as described later.

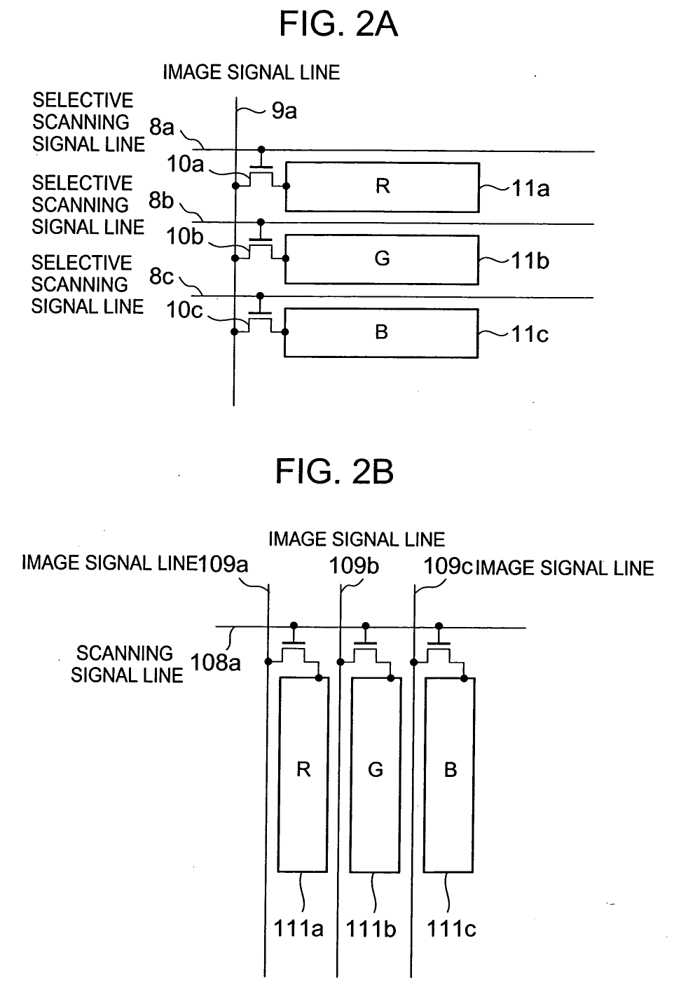

FIGS. 2A and 2B are explanatory diagrams showing a pixel arrangement in the liquid crystal display portion 5. FIG. 2A shows a pixel arrangement in this embodiment and FIG. 2B shows a typical pixel arrangement in a conventional example.

As shown in FIG. 2A, in this embodiment, pixels 11a, 11b, and 11c in which color filters of R, G, and B corresponding to three primary colors are located are arranged in a longitudinal direction of a screen. The pixels 11a, 11b, and 11c are connected with an image signal line 9a commonly used through pixel TFTs 10a, 10b, and 10c.

Gates of the pixels TFTs 10a, 10b, and 10c are connected with selective scanning signal lines 8a, 8b, and 8c.

Hereinafter, when the same kinds of elements are not particularly distinguished from one another, each of the elements are expressed without using an alphabetic character as a subscript of reference numeral as in the case where a pixel TFT is expressed by reference numeral 10. On the other hand, when the respective elements are to be distinguished from one another, each of the elements is expressed using an alphabetic character as a subscript of reference numeral as in the case where the pixels TFTs are expressed by, for example, reference symbols 10a and 10b.

Each of the pixels TFTs 10a, 10b, and 10c is, for example, a switching element including a field effect transistor (FET). The gates of the pixels TFTs 10a, 10b, and 10c are connected with the selective scanning signal lines 8a, 8b, and 8c. A source of each of the pixels TFTs 10a, 10b, and 10c is connected with the image signal line 9a. Drains of the pixels TFTs 10a, 10b, and 10c are connected with the pixels 11a, 11b, and 11c.

When the scanning signal is supplied to the selective scanning signal line 8a to turn on the pixel TFT 10a, the pixel 11a is charged by a voltage corresponding to the image signal supplied through the image signal line 9a. After that, when the pixel TFT 10a is turned off in response to a signal from the selective scanning signal line 8a, a charge stored in the pixel 11a is held.

Similarly, when the pixel TFT 10b is turned on and off, the pixel 11b can be charged and a charge can be held. In addition, when the pixel TFT 10c is turned on and off, the pixel 11c can be charged and a charge can be held.

On the other hand, in the conventional example, pixels 111a, 111b, and 111c for R, G, and B are arranged in a lateral direction of the screen. A scanning signal line 108a commonly used among the pixels 111a, 111b, and 111c is provided.

The pixels 111a, 111b, and 111c are connected with image signal lines 109a, 109b, and 109c through sources of pixel TFTs.

When a scanning signal is supplied to the scanning signal line 108a to turn on the pixel TFT, the pixel 111a is charged by an image signal supplied through the image signal line 109a. Similarly, the pixel 111b is charged by an image signal supplied through the image signal line 109b and the pixel 111c is charged by an image signal supplied through the image signal line 109c.

As described above, although the pixels for R, G, and B are arranged in the lateral direction in the conventional example, the pixels for R, G, and B are arranged in the longitudinal direction in this embodiment. Therefore, according to this embodiment, the image signal line 9a is commonly used among the pixels for three primary colors, so the number of image signal lines can be reduced.

The number of scanning signal lines becomes three times that in the conventional example, so the liquid crystal display portion 5 is scanned using the scanning signal lines three times greater in number than those in the conventional example.

However, the case where digital signals (scanning signals) to be supplied are switched thereamong at high speed is easier than the case where analog signals (image signals) to be supplied are switched thereamong at high speed. Therefore, the control in the case where the number of image signal lines is reduced and the number of scanning signal lines is increased is easier and an image is stably obtained.

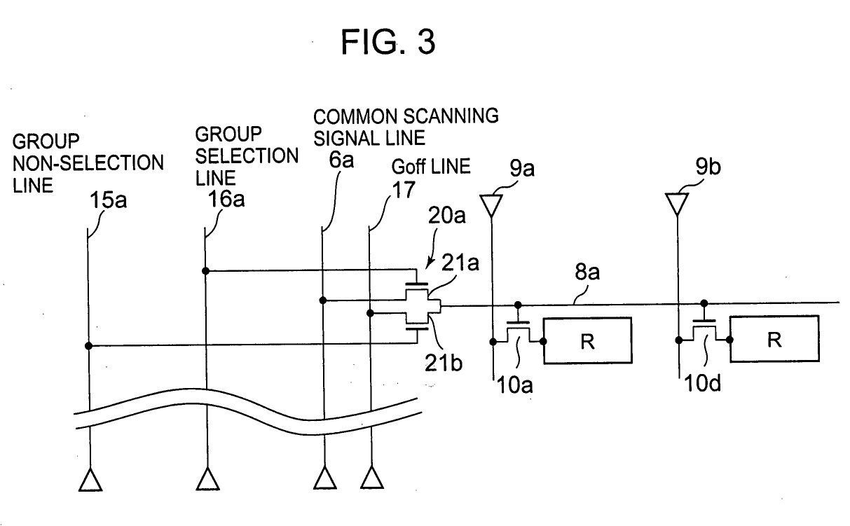

FIG. 3 is an explanatory diagram showing a mechanism for group selection.

The selective scanning signal line 8a is connected with a selector TFT 20a composed of two TFTs 21a and 21b combined with each other, which is included in the group selective scanning circuit 4.

A drain of each of the TFTs 21a and 21b is connected with the selective scanning signal line 8a. A source of the TFT 21a is connected with a common scanning signal line 6a and a gate thereof is connected with a group selection line 16a.

On the other hand, a source of the TFT 21b is connected with the Goff line 17 and a gate thereof is connected with a group non-selection line 15a.

Hereinafter, the description will be made on the assumption that each of TFTs 21a and 21b is turned on when a gate voltage is “H” (high level) and each thereof is turned off when the gate voltage is “L” (low level).

In FIG. 3, when a voltage on the group selection line 16a becomes “H” and a voltage on the group non-selection line 15a becomes “L”, the TFT 21a is turned on and the TFT 21b is turned off.

Then, the selective scanning signal line 8a is connected with the common scanning signal line 6a through the TFT 21a, so the scanning signal can be transferred to the selective scanning signal line 8a. Therefore, the pixel TFTs 10a and 10b can be turned on and off in response to the scanning signal.

In contrast to this, when the voltage on the group selection line 16a becomes “L” and the voltage on the group non-selection line 15a becomes “H”, the TFT 21a is turned off and the TFT 21b is turned on. Then, the selective scanning signal line 8a is connected with the Goff line 17 through the TFT 21b.

A voltage on the Goff line 17 is held to a voltage for turning off the pixel TFTs 10a and 10b. When the voltage on the Goff line 17 is applied to the gate of each of the pixel TFTs 10a and 10b, the pixel TFTs 10a and 10b are turned off. Therefore, the common scanning signal line 6a and the selective scanning signal line 8a are disconnected with each other.

Thus, when the selector TFT 20a is used, the selective scanning signal line 8a can be connected with the common scanning signal line 6a or the Goff line 17 based on the signal voltages on the group non-selection line 15a and the group selection line 16a.

As described above, the selector TFT 20a is a five-terminal element which has a terminal connected with the common scanning signal line 6 (hereinafter referred to as a common scanning signal terminal), a terminal connected with selective scanning signal line 8 (hereinafter referred to as a selective scanning signal terminal), a terminal connected with the Goff line 17 (hereinafter referred to as a Goff terminal), a terminal connected with the group selection line 16 (hereinafter referred to as a selection terminal), and a terminal connected with the group non-selection line 15 (hereinafter referred to as a non-selection terminal). According to such a switching element, when a voltage at the selection terminal is “H” and a voltage at the non-selection terminal is “L”, the common scanning signal terminal is connected with the selective scanning signal terminal. In addition, when the voltage at the selection terminal is “L” and the voltage at the non-selection terminal is “H”, the common scanning signal terminal is disconnected with the selective scanning signal terminal.

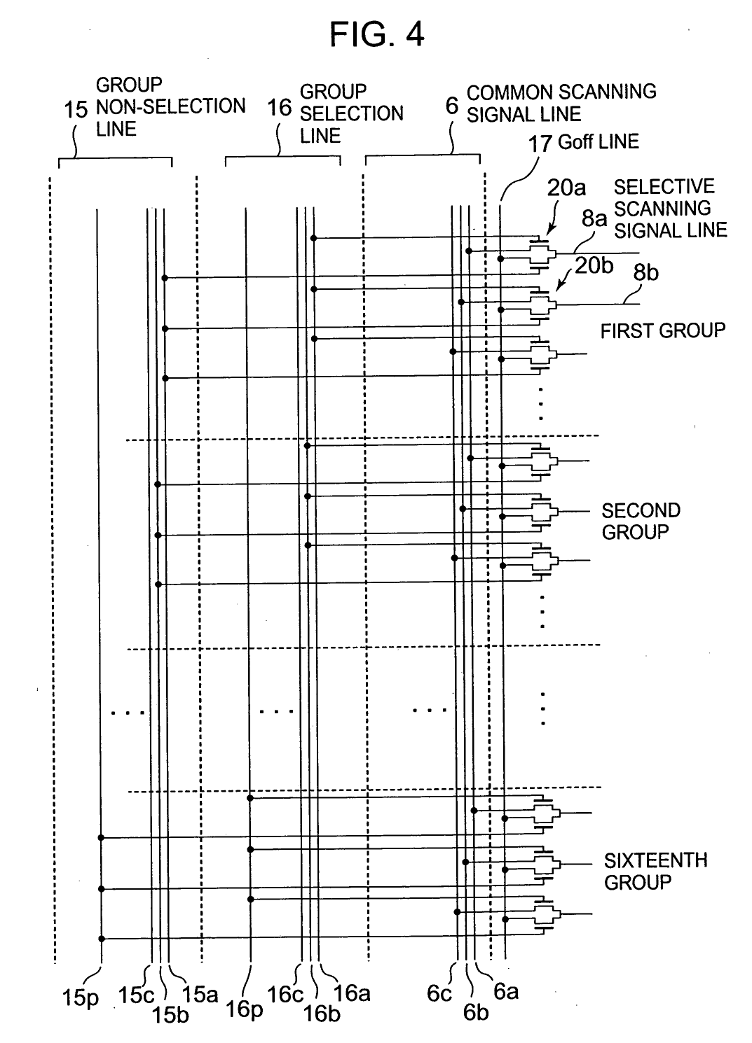

FIG. 4 is an explanatory diagram showing the entire wiring structure of the group selective scanning circuit 4.

The common scanning signal line 6 includes 30 common scanning signal lines 6a, 6b, . . . and the group selection line 16 includes 16 group selection lines 16a to 16p. In addition, the group non-selection line 15 includes 16 group non-selection lines 15a to 15p.

Hereinafter, for the sake of convenience, a 30th common scanning signal line 6 is expressed as a common scanning signal line 6z. That is, symbol “z” is used as a subscript indicating a 30th line.

Of the wirings, a wiring connected with a scanning signal terminal of a selector TFT 20 will be first described.

The common scanning signal terminal of the first selector TFT 20a counted from the top of a first group is connected with the common scanning signal line 6a. A scanning signal terminal of a second selector TFT 20b counted from the top of the first group is connected with the common scanning signal line 6b. In the same manner as described above, a scanning signal terminal of a 30th selector TFT 20z is connected with a common scanning signal line 6z (not shown).

The same wiring structure is used for each of a second group to a sixth group. The common scanning signal terminal of the first selector TFT 20 located in the top of each of the groups is connected with the common scanning signal line 6a. The common scanning signal terminal of the second selector TFT 20 is connected with the common scanning signal line 6b. In the same manner as described above, the common scanning signal terminal of the 30th selector TFT 20 is connected with the common scanning signal line 6z.

The Goff terminal of each of the selector TFTs 20 is connected with the Goff line 17 without depending on the groups.

With respect to the selection terminals of the selector TFTs 20, the selection terminal of each of the selector TFTs 20 in the first group is connected with the group selection line 16a and the selection terminal of each of the selector TFTs 20 in the second group is connected with the group selection line 16b. That is, the selection terminal of each of the selector TFIs 20 in the nth group is connected with the nth group selection line 16.

With respect to the non-selection terminals of the selector TFTs 20, the non-selection terminal of each of the selector TFTs 20 in the first group is connected with the group non-selection line 15a and the non-selection terminal of each of the selector TFTs 20 in the second group is connected with the group non-selection line 15b. That is, the non-selection terminal of each of the selector TFTs 20 in the nth group is connected with the nth group non-selection line 15.

In the above-mentioned wiring structure, for example, when the nth group selection line 16 is set to “H” and each of group non-selection lines 15 other then the nth group non-selection line is set to “L”, the nth group becomes a selection state. Then, the scanning signal outputted to the common scanning signal line 6 is outputted to the selective scanning signal line 8 connected with each of the selector TFTs 20 in the nth group.

Therefore, when the scanning signal line driver circuit 3 controls the output signals from the group non-selection line 15 and the group selection line 16, the common scanning signal line 6 can be connected with the selective scanning signal line 8 of a predetermined group.

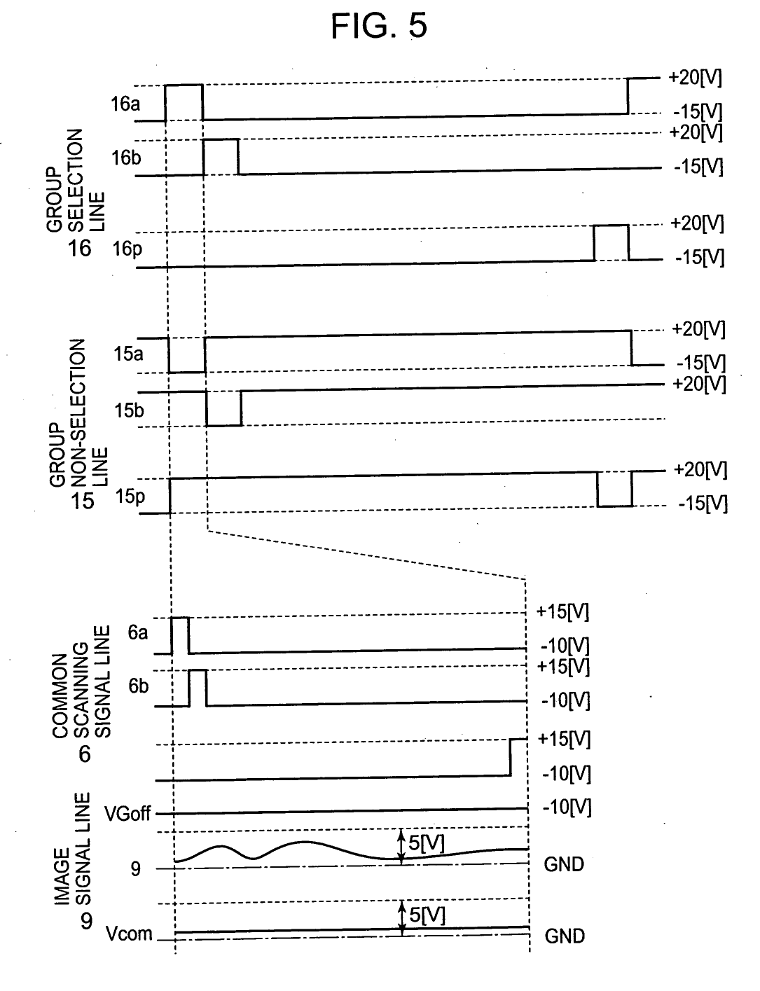

FIG. 5 is a waveform diagram showing output timings of the scanning signal and the like in the image display device 1.

A liquid crystal screen scanning method is normally divided into a line reverse method and a frame reverse method. Here, the case of the frame reverse method will be described.

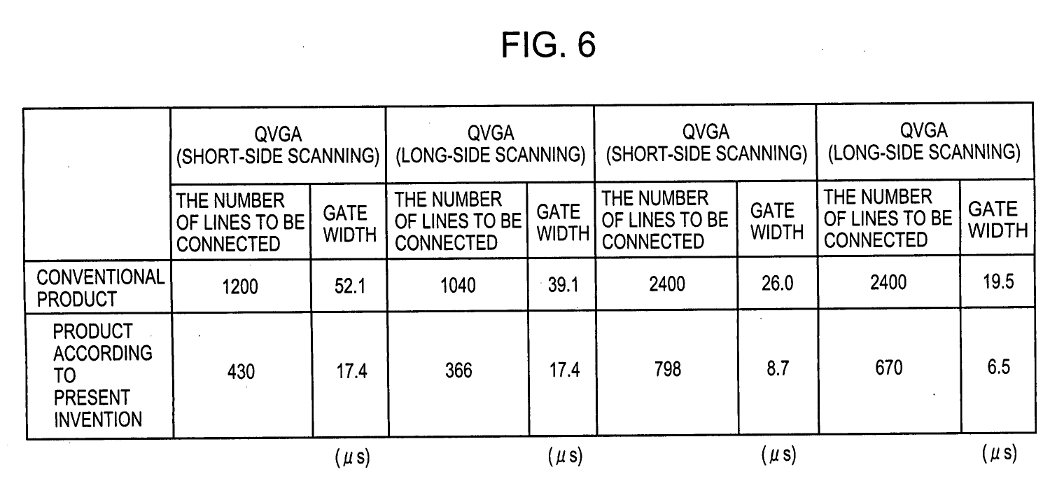

First, the group selection control performed by the scanning signal line driver circuit 3 will be described with reference to the waveform diagram with respect to the group selection line 16 and the group non-selection line 15 as shown in FIG. 6.

The scanning signal line driver circuit 3 outputs +20 V (H) and −15 V (L) to the group selection line 16 and the group non-selection line 15. The level of each of “H” and “L” is an example and thus can be arbitrarily set.

When the first group is to be selected, the scanning signal line driver circuit 3 sets “H” to the group selection line 16a of the group selection line 16 and sets “L” to each of the other group selection lines 16b to 16p thereof.

In synchronization with this, the scanning signal line driver circuit 3 sets “L” to the group non-selection line 15a of the group non-selection line 15 and sets “H” to each of the other group non-selection lines 15b to 15p thereof.

When such setting is performed, the selector TFTs 20 of the first group are connected with the common scanning signal line 6 and the selector TFTs 20 of each of the other groups are disconnected therewith.

Then, while the first group is connected with the common scanning signal line 6, the scanning signal line driver circuit 3 scans the first group. After the scanning of the first group is completed, the second group is selected.

When the second group is to be selected, the scanning signal line driver circuit 3 sets “H” to the group selection line 16b and sets “L” to each of the other group selection lines 16. In addition, the scanning signal line driver circuit 3 sets “H” to the group non-selection line 15b and sets “L” to each of the other group non-selection lines 15.

In general, when the nth group is to be selected, the scanning signal line driver circuit 3 sets “H” to the nth group selection line 16 and sets “L” to each of the other group selection lines 16. In addition, the scanning signal line driver circuit 3 sets “H” to the nth group non-selection line 15 and sets “L” to each of the other group non-selection lines 15.

Then, the scanning signal line driver circuit 3 scans the selected nth group. Next, the scanning signal line driver circuit 3 selects an (n+1)th group and scans the selected group. Therefore, the first group to the sixth group are scanned in this order. After scanning of the entire screen is completed, the scanning is repeated from the first group.

In this embodiment, the first group to the sixteenth group are selected in this order. However, a group selection order is not limited to this and thus can be arbitrarily set.

Next, the case where the scanning signal line driver circuit 3 scans a selected group will be described with reference to another waveform diagram.

In FIG. 6, a signal on the common scanning signal line 6, VGoff, a signal on an image signal line 9, and Vcom indicate signals generated while the first group is selected by the group non-selection line 15 and the group selection line 16.

With respect to the common scanning signal line 6, first, the scanning signal line driver circuit 3 sets “H” to the common scanning signal line 6a and sets “L” to each of the common scanning signal lines 6b to 6z. Therefore, “H” is set to the selective scanning signal line 8a and “L” is set to each of the selective scanning signal lines 8b to 8z.

Then, the pixel TFT 10 of a first pixel line of the first group is turned on and the pixel TFT 10 of each of the other pixel lines is turned off. Therefore, the first pixel line is charged by voltages of image signals outputted to the image signal lines 9. FIG. 6 shows an example of one of 240 image signal lines 9 and a voltage thereon shows an analog value of 0 V to +5 V.

After the scanning signal is outputted to the first pixel line, the scanning signal line driver circuit 3 sets “H” to the common scanning signal line 6b and sets “L” to each of the common scanning signal lines 6. Therefore, “H” is set to the selective scanning signal line 8b and “L” is set to each of the selective scanning signal lines 8. Then, the second pixel line is charged by the voltages of the image signals on the image signal lines 9.

Thus, the scanning signal line driver circuit 3 scans the common scanning signal lines 6a to 6z in order at a predetermined time interval (timing). The common scanning signal line 6 is connected with the selective scanning signal line 8, so the selective scanning signal lines 8a to 8z connected therewith are also scanned.

After the scanning signal line driver circuit 3 scans an image signal line 9z, the next group is selected and pixel lines thereof are scanned in order in the same manner.

In this embodiment, the first selective scanning signal line 8a to the 30th selective scanning signal line 8z are scanned in order. However, the present invention is not limited to such scanning and thus the scanning order can be arbitrarily set.

Reference symbol VGoff indicates a signal waveform outputted from the scanning signal line driver circuit 3 to the Goff line 17. A predetermined value of −15 V is set as VGoff. This voltage is used as a voltage for turning off the pixel TFT 10.

Reference symbol Vcom indicates a waveform of a voltage outputted to a common electrode commonly provided to the respective pixels of the liquid crystal display portion 5. Each of the pixels includes a charge electrode charged by a charge supplied through the image signal line 9, the common electrode opposed to the charge electrode, and a liquid crystal provided between the charge electrode and the common electrode. The liquid crystal is driven by a potential difference between the charge electrode and the common electrode.

A value of 0 V to 5 V can be set as Vcom. In this embodiment, a predetermined voltage slightly larger than 0 V is set.

In this embodiment, the frame reverse method is employed, so each of VGoff and Vcom is the predetermined value. When the line reverse method is to be employed, an output is changed in synchronization with the scanning signal.

FIG. 6 is a table in which the image display device according to this embodiment is compared with an image display device which is a conventional product.

The comparison is made with respect to four types of QVGA (short-side scanning), QVGA (long-side scanning), and VGA (short-side scanning), and VGA (long-side scanning).

The short-side scanning means a scanning type of scanning a side in which the number of pixels is small. The long-side scanning means a scanning type of scanning a side in which the number of pixels is large.

As shown in the table, for example, in the case of the QVGA (short-side scanning), the number of scanning signal lines (or the number of image signal lines) connected with the driver IC in the conventional product is 1200. In contrast to this, in this embodiment, the driver IC (image signal line driver circuit 2 and scanning signal line driver circuit 3) is connected with the TFT liquid crystal panel 100, so the number of lines to be connected becomes 430. Therefore, the number of lines is reduced to approximately ⅓.

A gate width indicates a time necessary to scan each pixel line based on the scanning signal. In the case of the conventional product, the time is 52.1 μS. In contrast to this, the time is 17.4 μS in this embodiment. Therefore, scanning is performed at speed which is approximately three times that in the case of the conventional product.

This reason is as follows. In this embodiment, the color filters are arranged in the longitudinal direction as shown in FIG. 2A, so the number of scanning signal lines becomes three times that in the case of the conventional product.

Even in the other types, the number of lines connected with the driver IC is reduced to approximately ⅓.

As described above, the liquid crystal display portion 5 serves as an image display portion in which a plurality of pixel lines, each of which includes a plurality of pixels, are arranged. The image signal line driver circuit 2 serves as image signal output means for outputting an image signal to each of the pixels.

The selective scanning signal line 8 serves as a first scanning signal line connected with a pixel line, for generating a scanning signal for applying the outputted image signal to each of pixels composing the pixel line. Here, “applying the image signal to the pixel” means, for example, “charging the pixel”.

The scanning signal line driver circuit 3 serves as scanning signal output means including the common scanning signal 6 which is a second scanning signal line for sending the scanning signal.

In addition, the scanning signal line driver circuit 3 serves as scanning signal line connecting means for controlling the selector TFT 20 to connect the common scanning signal 6 with the selective scanning signal line 8.

The liquid crystal display portion 5 includes a pixel line set composed of pixel lines connected with the different second scanning signal line through the first scanning signal line, that is, a group. The scanning signal line driver circuit 3 controls the connection and disconnection between the common scanning signal 6 and the selective scanning signal line 8 for each group.

The selector TFT 20 serves as switching means for parallel connecting the plurality of selective scanning signal lines 8 with the common scanning signal 6.

When the common scanning signal 6 and the selective scanning signal line 8 are disconnected with each other, according to the scanning signal line driver circuit 3, the pixel TFT 10 is tuned off in response to the Goff signal (which serves as a state holding signal line) to hold a state in which an image signal is applied (state in which charge is stored). This serves as state holding means.

As shown in FIG. 2A, the color filters are arranged in the longitudinal direction. Therefore, the selective scanning signal line 8 is provided for each of the three pixels corresponding to the three primary colors and the image signal line 9 for supplying the image signal is commonly provided to the three pixels.

As described above, in this embodiment, the pixel TFT 10 and the selector TFT 20 are provided for two-stage gate structure, so each of the region groups into which the liquid crystal display portion 5 is divided can be selected and scanned.

In this embodiment, the color filters are arranged in not the lateral direction but the longitudinal direction. Therefore, the number of scanning lines (the number of gates of the pixel TFTs) is increased to three times, with the result that the number of signal lines (the number of sources of the pixel TFTs) can be reduced to ⅓. When the color filters are arranged in not the lateral direction but the longitudinal direction, the number of scanning lines increases. However, when the liquid crystal display portion 5 is divided into the groups, the number of lines to be connected in the entire panel reduces.

As described above, the number of wirings to be connected with the driver IC reduces, so a reduction in size of the driver IC, a reduction in cost, and an increase in mounting yield can be achieved.

A wiring pitch is rough, so COF (connection with flexible board) is also possible. If so, a COG portion (portion in which the driver IC is located) of the panel is omitted, so an area of the entire panel can be reduced by approximately 4%.

In this embodiment, the example of the active matrix a-Si TFT liquid crystal panel of QVGA is described. However, the present invention is not limited to this and thus can be widely applied to a display device in which the number of scanning signal lines of the driver IC is reduced by switching between the scanning signal lines of the driver IC and the scanning signal lines of the panel, such as a liquid crystal panel of another specification or a plasma display.

In this embodiment, the pixel TFT 10 requires a gate voltage of approximately 25 V (+15 V and −10 V). Therefore, a gate voltage of the selector TFT 20 is set to 35 V (+20 V and −15 V). In recent years, a driver IC for controlling a voltage of approximately 35 V is widely used, so the scanning signal line driver circuit 3, the image signal line driver circuit 2, or the like can be constructed using such a driver IC.

### MODIFIED EXAMPLE 1

Next, Modified Example 1 will be described. In this modified example, a pixel line group (pixel line set) is formed for each group including the color pixel lines corresponding to, R, G, and B, that is, the three primary colors.

In the image display device 1, the same image signal line 9 is connected with pixels 11 corresponding to R, G, and B. Therefore, when the liquid crystal display portion 5 is scanned in a direction from an upper end to a lower end (or reverse direction) in order, the signal traveling on the image signal line 9 is switched to one of the image signal of R, the image signal of G, and the image signal of B every time the scanning signal moves from a pixel line to next pixel line.

Therefore, the image signal traveling on the image signal line 9 significantly varies, so there may occur an inconvenience such as a crosstalk.

The liquid crystal display portion 5 is not necessarily scanned from the upper end to the lower end in order. Scanning lines may be discretely scanned.

Thus, in this embodiment, a group is formed for each of pixel lines of R, G, and B. First, a group for R is scanned. Next, a group of G is scanned. After that, a group of B is scanned. This is because the image signal of preferably the same color is caused to travel on the image signal line 9.

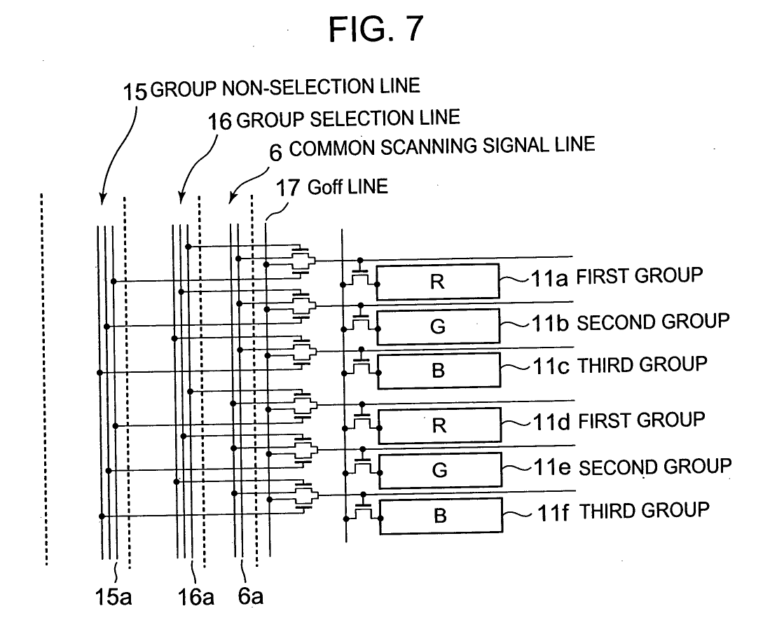

FIG. 7 is an explanatory diagram showing a structure including the pixels 11 and wirings in the case where a group is formed for each of lines of R, G, and B.

As shown in FIG. 7, each of a pixel 11a and a pixel 1d, each of which has a light emission color of R, is connected with the group selection line 16a and the group non-selection lien 15a and belongs to a first group.

The pixel 11a is connected with the common scanning signal line 6a. The pixel 11d is connected with the common scanning signal line 6b. When the first group is selected, sequential scanning can be performed.

In order to avoid complication, reference symbols of lines subsequent to the common scanning signal line 6a, lines subsequent to the group selection line 16a, and lines subsequent to the group non-selection line 16a are omitted in FIG. 7.

Each of pixel lines (not shown) of R which are located below a pixel line including the pixel 11d is connected with the group selection line 16a and the group non-selection line 15a. The pixel lines of R are connected with the common scanning signal lines 6c, 6d, . . . in order.

Note that various wirings can be used for the group selective scanning circuit 4. For example, the liquid crystal display portion 5 is divided into three groups. It is assumed that the pixel lines of R belong to the first group, the pixel lines of G belong to a second group, and the pixel lines of B belong to the third group. In such a case, a selector portion of the group selective scanning circuit 4 includes three group non-selection lines 15 and three group selection lines 16. The number of common scanning signal lines 6 is 160.

In this case, when the scanning signal driver circuit 3 sequentially selects the first group to the third group and scans the selected group, scanning can be performed for each color of R, G, and B.

As in the case of Modified Example 2 described later, the pixel lines of R are divided into two groups. In addition, the pixel lines of each of G and B are further divided into two groups. Therefore, a first group to a sixth group can be constructed.

In such a case, the selector portion of the group selective scanning circuit 4 includes six group non-selection lines 15 and six group selection lines 16. The number of common scanning signal lines 6 is 80.

In this case, when the scanning signal driver circuit 3 sequentially selects and scans the first group to the sixth group, scanning can be performed for each light emission color of R, G, and B.

The pixel lines of each of R, G, and B can be divided into more groups.

When the pixel lines are divided into 16 groups as in the case of the above-mentioned embodiment, a first group to a fifteenth group can be set as color selective groups (five groups can be obtained for each of R, G, and B) and a sixteenth group can be set as a mixture group having R, G, and B.

When the sixteenth group is to be scanned, the scanning signal driver circuit 3 selects a color which is being scanned and then scans a pixel line of the selected color.

For example, when the pixel lines of R are to be scanned, the scanning signal driver circuit 3 selects each group of the pixel lines of R from fifteen groups including the first group to the fifteenth group and then scans the selected group. In the case of the sixteenth group, only the pixel line of R which is included in the sixteenth group is scanned.

The wirings in the group selective scanning circuit 4 and the scanning method executed by the scanning signal driver circuit 3 as described above are examples and thus various examples can be provided.

When the group selective scanning circuit 4 having the above-mentioned structure is used, the scanning signal driver circuit 3 can scan the liquid crystal display portion 5 for each separation color. Light emission can be produced in the pixel lines for each of the groups by the image signal line driver circuit 2.

As described above, the scanning signal driver circuit 3 and the group selective scanning circuit 4 correspond to driver means.

While the same group is being scanned, only an image signal of a color associated with this group is transferred to the common scanning signal line 6. Therefore, a large variation in image signal can be reduced.

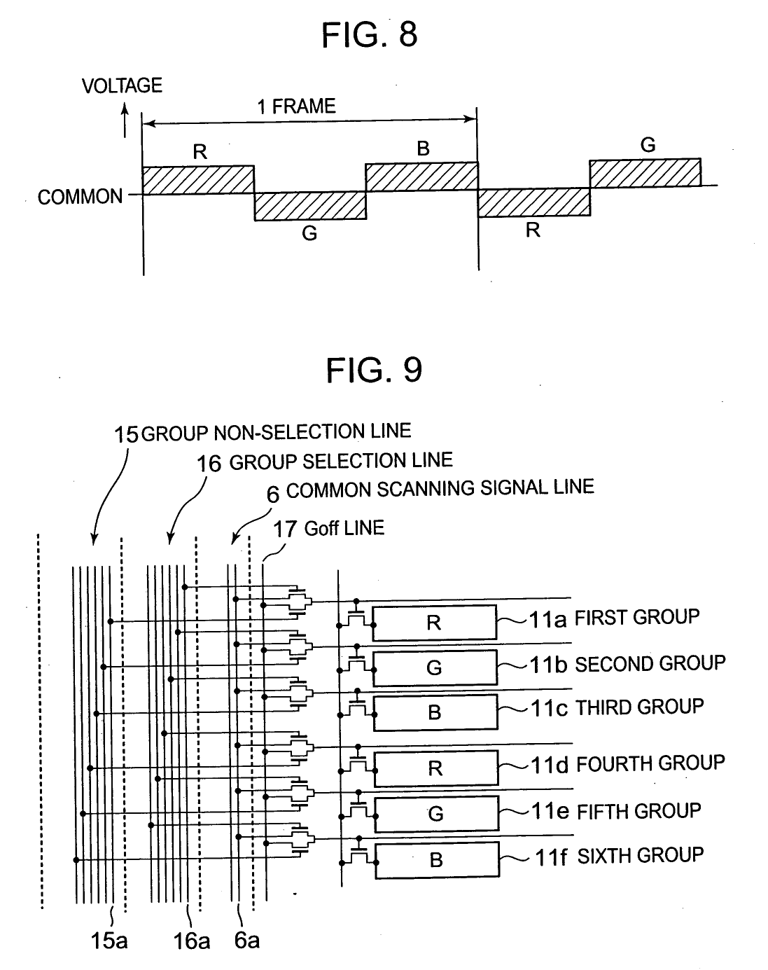

FIG. 8 is an explanatory diagram showing an example of a method of scanning the liquid crystal display portion 5 of the image display device 1 in Modified Example 1. FIG. 8 shows a source output waveform. The ordinate indicates a voltage applied to a pixel electrode of the pixel 11 and the abscissa indicates a time. A common electrode is assumed to be grounded. The common electrode may be biased.

As shown in FIG. 8, in the image display device 1, the group of R is scanned with a plus polarity. After that, the polarity is reversed and the group of G is scanned with a minus polarity. Then, the polarity is reversed again and the group of B is scanned with the plus polarity. As a result, one frame is formed.

In the image display device 1, after that, the voltage applied to the pixel is reversed in the same manner every time the pixel line group is scanned.

When the polarity is reversed, the power consumption can be reduced. In addition to this, the plus polarity and the minus polarity are cancelled, so a crosstalk can be reduced.

For example, during the one frame shown in FIG. 8, the plus polarity of R is canceled with the minus polarity of G, so the amount of crosstalk corresponds to only the plus polarity of B.

Thus, according to the scanning method in this modified example, low power consumption can be achieved while the crosstalk is suppressed.

### MODIFIED EXAMPLE 2

In this modified example, the group of each of R, G, and B is divided into an even group and an odd group, with the result that the groups of R, G, and B are divided into six groups. To be specific, the pixel lines of R are divided into an even-numbered pixel line group and an odd-numbered pixel line group which are counted from the uppermost line. The pixel lines of G are divided into an even-numbered pixel line group and an odd-numbered pixel line group. The pixel lines of B are divided into an even-numbered pixel line group and an odd-numbered pixel line group.

For example, in an example shown in FIG. 9, the pixel 11a is assumed to belong to an even-numbered pixel line of the pixel lines of R and is included in the first group.

Similarly, the pixel 11b is assumed to belong to an even-numbered pixel line of the pixel lines of G and is included in the second group. In addition, the pixel 11c is assumed to belong to an even-numbered pixel line of the pixel lines of B and is included in the third group.

The pixel 11a is the even number, so the pixel 11d belongs to an odd-numbered pixel line and is included in the fourth group.

Similarly, the pixel 11e belongs to an odd-numbered pixel line and is included in the fifth group. In addition, the pixel 11f belongs to an odd-numbered pixel line and is included in the sixth group.

In the lower pixel lines (not shown), the same pattern as described above is repeated, for example, the first group to the sixth group, the first group to the sixth group, . . . .

With respect to the wiring for the group non-selection line 15 and the group selection line 16, the pixel line of the first group is connected with the group non-selection line 15a and the group selection line 16a. Although reference symbols are not shown, the pixel line of the second group is connected with the group non-selection line 15b and the group selection line 16b. The same connection is made for each group.

With respect to the wiring between the common scanning signal line 6 and each group, a first pixel line is connected with the common scanning signal line 6a and a second pixel line is connected with the common scanning signal line 6b. The same connection is made for each pixel line.

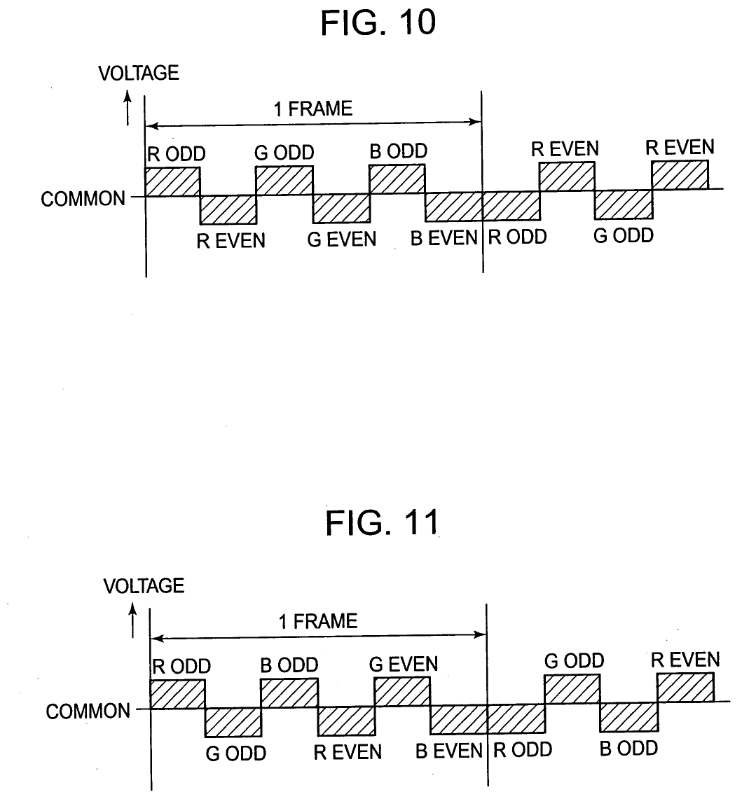

FIG. 10 is an explanatory diagram showing an example of a scanning method of scanning the liquid crystal display portion 5 of the image display device 1 in Modified Example 2.

As in the case of FIG. 8, the ordinate indicates a voltage applied to the pixel electrode and the abscissa indicates a time.

Hereinafter, for example, the even-numbered pixel line of the pixel lines of R is expressed by R (even).

As shown in FIG. 10, in the image display device 1, a group of R (odd) is scanned with a plus polarity. Then, the polarity is reversed and a group of R (even) is scanned with a minus polarity. Subsequently, the polarity is reversed and a group of G (odd) is scanned. Then, a group of G (even) is scanned with the minus polarity. Subsequently, the polarity is reversed and a group of B (odd) is scanned. Then, a group of B (even) is scanned with the minus polarity. As a result, one frame is completed.

Hereinafter, in the same manner as described above, light emission is produced in the pixel lines for each group while the electrode polarity is reversed every time the pixel line group is scanned.

When the polarity is reversed, the power consumption can be reduced. In addition to this, the plus polarity and the minus polarity are cancelled, so a crosstalk can be reduced.

For example, during the one frame shown in FIG. 10, the plus polarity of R (odd) is canceled with the minus polarity of R (even). Similarly, the polarity of G (odd) and the polarity of G (even) are cancelled, and the polarity of B (odd) and the polarity of B (even) are cancelled. That is, both the polarities provided in the frame for each color are cancelled.

FIG. 11 shows another scanning method in Modified Example 2. As shown in FIG. 11, the group of R (odd) is scanned with the plus polarity, the group of G (odd) is scanned with the minus polarity, and then the group of B (odd) is scanned with the plus polarity. That is, the odd group is scanned while the polarity is reversed for each color. Then, the even group is scanned while the polarity is reversed for each color. Such scanning is also possible.

A scanning pattern is not limited to such a pattern. It is preferable to perform scanning while the polarity is reversed for each group. A group scanning order can be arbitrarily set.

According to Modified Examples 1 and 2 described above, the following effects can be obtained.

(1) The two-stage gate structure is employed. When a region is to be selected and scanned, frame reverse driving for performing frame reversal for each color is used as the driving method. Therefore, gate region division can be performed based on the scanning order.

(2) In the case of Modified Example 1, the color filters are arranged in not the lateral direction but the longitudinal direction. Therefore, when R, G, and B are arranged in order from the top, only the group of R is first scanned with the plus polarity. Then, the group of G is scanned with the minus polarity. Then, the group of B is scanned with the plus polarity. Thus, when sub scanning is performed three times in total, one frame can be formed. When next frame is to be formed, each color polarity is reversed. That is, the group of R is scanned with the minus polarity, the group of G is scanned with the plus polarity, and the group of B is scanned with the minus polarity. Hereinafter, in the same manner as described above, each frame can be formed during the polarity reversal.

(3) In Modified Example 2, the group of each of R, G, and B is further divided into an even group and an odd group which are expressed by, for example, R (even) and R (odd). Therefore, scanning can be performed during the polarity reversal.

(4) Scanning is performed for each color, so a variation in image signal supplied from the image signal line driver circuit 2 through the image signal line 9 can be reduced. Therefore, an inconvenience such as a crosstalk can be reduced.

(5) The frame reversal is performed for each color, so the plus polarity and the minus polarity can be cancelled to reduce the crosstalk.

What is claimed is:

1. An image display device, comprising:
an image display portion in which a plurality of pixel lines, each of which includes a plurality of pixels, are arranged;
image signal output means for outputting an image signal to the pixels;
scanning signal output means including:
a plurality of first scanning signal lines connected with the pixel lines, for supplying, to the pixels of each of the pixel lines, a scanning signal for applying the output image signal; and
a second scanning signal line for sending the scanning signal; and
scanning signal line connecting means for connecting a first scanning signal line connected with a pixel line to which the scanning signal is supplied, of the plurality of first scanning signal line, with the second scanning signal line.

2. An image display device according to claim 1, wherein:
the image display portion includes a plurality of pixel line groups, each of which has pixel lines connected with the different second scanning signal line through the first scanning signal line; and
the scanning signal line connecting means performs one of connection and disconnection between the first scanning signal line and the second scanning signal line for each of pixel line groups.

3. An image display device according to claim 1, wherein:
the scanning signal line connecting means includes switching means for parallel connecting the plurality of first scanning signal lines with the second scanning signal line; and
connection of the switching means is performed for each of the first scanning signal lines to connect the first scanning signal lines with the second scanning signal line.

4. An image display device according to claim 3, further comprising state holding means for supplying, to a pixel line connected with a first scanning signal line, a state holding signal for holding a state in which the image signal is applied when the first scanning signal line is disconnected with the second scanning signal line.

5. An image display device according to claim 4, wherein when the first scanning signal line is disconnected with the second scanning signal line, the state holding means supplies the state holding signal by connecting a state holding signal line with the disconnected first scanning signal line.

6. An image display device according to claim 1, further comprising an image signal line for supplying the image signal, wherein:
the first scanning signal lines are separately provided for three pixels corresponding to three primary colors; and
the image signal line is commonly provided to the three pixel.

7. An image display device according to claim 2, wherein
each of the pixel line groups is formed for pixels of colors corresponding to three primary colors.

8. An image display device according to claim 7, further comprising driving means for driving the image signal output means and the scanning signal line connecting means to scan the pixels for each of the pixel line groups for light emission.

9. An image display device according to claim 8, wherein the driving means reverses a polarity of a voltage applied to a pixel electrode every time each of the pixel line group is scanned.

10. An image display method for an image display device in which pixels corresponding to three primary colors are connected with a single image signal line, comprising:
a first light emission step of scanning pixels corresponding to a first color of the three primary colors to produce light emission in the pixels corresponding to the first color;
a second light emission step of scanning pixels corresponding to a second color of the three primary colors to produce light emission in the pixels corresponding to the second color; and
a third light emission step of scanning pixels corresponding to a third color of the three primary colors to produce light emission in the pixels corresponding to the third color.
